(19) United States
(12) Patent Application Publication
(10) Pub. No.: US 2010/0236860 A1
(43) Pub. Date: Sep. 23, 2010

(54) Electric power steering

(75) Inventors: Juergen Hoersh, Gschwend (DE); Arthur Rupp, Huettlingen (DE); Andreas Kruttschnitt, Hoidenheim (DE); Jochen Nussbaumer, Waldstetten (DE); Wolfgang Runge, Ravensburg (DE)

Correspondence Address: JORDAN AND HAMBURG LLP, 122 EAST 42ND STREET, SUITE 4000, NEW YORK, NY, 10168, US

(73) Assignee: ZF Lenksysteme GmbH, Schwaebisch Gmuend (DE)

(21) Appl. No.: 12/800,931

(22) Filed: May 26, 2010

Related U.S. Application Data
(63) Continuation of application No. PCT/EP09/00555, filed on Jan. 29, 2009.

(30) Foreign Application Priority Data
Feb. 1, 2008 (DE) 10 2008 000 213.5

(51) Int. Cl. B62D 5/04

(52) U.S. Cl. 180/444

(57) ABSTRACT

An electric power steering system, and in particular a power-assisted steering system for a vehicle, comprises a steering transmission housing and a housing cover which forms an axial closure of the steering transmission housing and which is penetrated by an axially displaceable component of the steering transmission. In order to provide an electric power steering system which is easy to assemble and is not susceptible to wear, in an axially outer region of the housing cover, a first guide bushing for the axially displaceable component is integrated in the housing cover.

This is a Continuation of U.S. National Stage of PCT/EP2009/000555 filed Jan. 29, 2009.

The invention relates to an electric power steering system, and in particular to a power-assisted steering system for a vehicle.

### BACKGROUND OF THE INVENTION

DE 21 58594 describes a power-assisted steering system for a vehicle, comprising a steering transmission, in the steering transmission housing of which, an axially displaceable component designed as a rack is guided. The rack is borne radially in the steering transmission housing by a guide bushing, the guide bushing being capable of compensating for bending of the rack by means of an angular offset. The suspension of the guide bushing in the steering transmission housing is complicated. The guide bushing is supported radially by means of a fixed collar in a receiving bore of a fitting which closes the steering transmission housing. In this case, a rubber sleeve vulcanized onto the guide bushing is pressed by the outer surface, which in part runs conically and in part is provided with longitudinal grooves, into the receiving bore in such a way that the guide bushing, on one hand bears axially with its collar against a shoulder of the receiving bore, and in so doing axially secures a sealing ring which is disposed at the end of the receiving bore and seals off the rack, and on the other hand is secured by a disc which is fixed between a cylindrical tube and the fitting.

Similarly complicated radial guides for racks are known in the case of electric power steering systems.

### SUMMARY OF THE INVENTION

The object of the invention is to provide an electric power steering system which is easy to assemble, which is not susceptible to wear, and which operates in a trouble-free manner.

Easy assembly of the electric power steering system is achieved by a first guide bushing for the axially displaceable component being integrated in advance, not into a steering transmission housing, but rather into a housing cover which axially closes this, and which is preferably fitted last, in the assembly of the steering transmission.

In one particularly preferred embodiment, the guide bushing is inserted as an insert in the manner of a core, for example, into a mold for the housing cover and is fixed in the housing cover by way of positive fitting and/or material bonding during casting of the housing cover.

A second guide bushing can be arranged in the housing cover and/or in the steering transmission housing, in the same manner, or differently. The guide bushings are preferably formed in one piece and have an axial stop function for the rack.

Preferably, the ratio of the guide diameter to the width of the guide bushing for the first and/or second guide bushing is between 0.3 and 3.5. Furthermore, the ratio of the wall thickness of the first and/or second guide bushing to the outer diameter thereof is preferably selected at 0.01 to 0.3, in order to avoid any jamming of the rack in the event of bending.

The axially displaceable component in the guide bushing may be guided in a linear guide by suitably choosing the cross-sectional profile of the guide bushing. A polygonal profile or a design wherein the guide bushing is a roller bearing is suitable for this. The tolerances for the diameter of the rack can thus be compensated within certain ranges.

It may be advantageous to mount the guide bushing in a radially elastic manner in the housing cover and/or in the steering transmission housing, or to mount it in the housing cover or the steering transmission housing with play, such that, under load, the guide bushing bears against the housing cover or the steering transmission housing.

The guide bushings can also be axially positioned and fixed, and in particular a device for adjusting and fixing the radial position in the housing cover or the steering transmission housing can be used, which consists, for example, of three adjusting screws tangentially spaced apart relative to the outer surface of the guide bushings, and which can define the radial position of the guide bushings in the housing cover. Eccentrics, double eccentrics and the like are also suitable as adjusting elements that serve as alternatives to screws. After positioning, the guide bushings can be clamped by screws or riveted, caulked, welded or adhesively bonded. A cavity between the outer surface of the guide bushings and the housing cover, in the radial direction, is suitable for introducing a compound which condenses or polymerizes elastomerically or a solidifying compound, in order to finally fix the guide bushings radially and axially. Preferably, the guide surfaces of the first and/or second guide bushing are shaped in such a way that they have a cross-sectional profile differing from a circular shape, so that they prevent the axially displaceable component from rotating. Moreover, the cross-sectional profile of the outer or inner surfaces of the guide bushings may be configured in such a way as to achieve linear bearing of the axially displaceable component against the respective guide bushing, or linear bearing of the guide bushing against the housing cover or steering transmission housing.

The outer and/or inner surfaces of the guide bushings may also be formed in a rounded manner, so that in the event of bending, a tilted position is possible for the axially displaceable component or the rack, and so that the guide bushing can follow the bend line of the rack.

The electric power steering system preferably drives a recirculating ball gear, and in particular with a view to radial guidance in the axial region of the rack against the recirculating ball gear, it may be advantageous if the tip circle of the recirculating ball gear is shaped in such a way that this can be used for radial bearing of the rack. The guide bushing in the region of the recirculating ball gear can be mounted in a radially elastic manner, while the guide bushing that is disposed at the end of the housing cover can be rigidly disposed.

It may also be advantageous to configure the recirculating ball gear in such a way that a housing therefor comprises multiple parts and can be oriented and fixed radially. It may also be advantageous to form the guide bushings as a passive recirculating ball gear.

The guide bushings are permanently lubricated by means of lubricating grooves or lubricating pockets. Suitable materials for the guide bushings are plastic, such as polyamides, polyoxymethylene, polyphenylene ether, polyethylene terephthalate and polybutylene terephthalate, as well as composite materials comprising metal and plastic or suitable bearing metals.

It may be advantageous to arrange structurally identical guide bushings at the axial ends of the steering transmission housing.

The invention will now be described in more detail with reference to an exemplary embodiment and will be illustrated on the basis of the appended drawing.

### BRIEF DESCRIPTION OF THE DRAWING

FIG. 1 shows a longitudinal section through an electric power steering system according to the invention.

### DESCRIPTION OF THE PREFERRED EMBODIMENTS

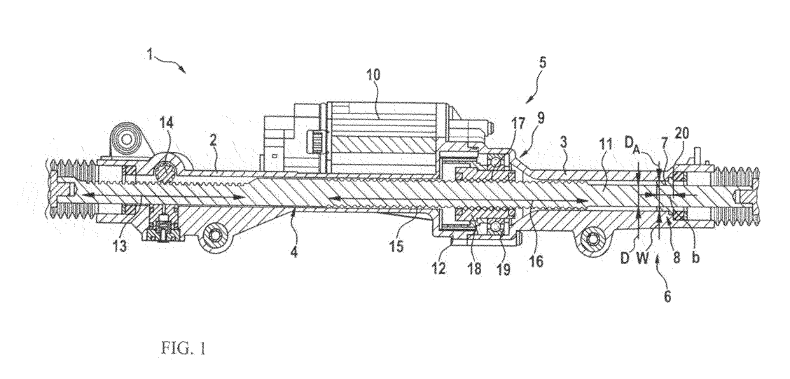

FIG. 1 shows, in a longitudinal section, an electric power steering system 1 formed as a rack-type power-assisted steering system for a car. An axially displaceable component 4, formed as a rack 11, is mounted in a cylindrical steering transmission housing 2 of a steering transmission 5. Parallel to the rack 11, an electric servomotor 10 is fixed to a radial flange 12 of the steering transmission housing 2. The rack 11 meshes at a toothed section 13 with a pinion 14 of a steering shaft and has a thread 15 on a spindle section 16 which is engaged with a recirculating ball thread 17 of a nut 18 of a recirculating ball gear 9. The nut 18 is connected in a rotationally fixed manner to a toothed belt pulley which is part of a traction gear mechanism accommodated in the region of the radial flange 12. A radial bearing 19 for the nut 18 is held in a cylindrically shaped housing cover 3 which is approximately the same length.

In an axially outer region 6 of the housing cover 3, which is formed in one piece as a light metal cast part, a first guide bushing 7 is integrated in the housing cover 3. The guide bushing 7 serves as a radial guide for the rack 11 and is formed in a cylindrical manner, with a collar 20. The guide bushing 7 is placed in a mold as an insert 8, made from metal, and light metal which forms the housing cover 3 is poured around it so that it is connected to the housing cover 3 by way of positive fitting and is integrated therewith.

The guide diameter D is selected so that the ratio with respect to the width b of the guide bushing 7 is approximately 0.3 to 3.5. The wall thickness of the guide bushing 7 is selected so that the ratio with respect to the outer diameter D_{A} thereof is between 0.01 and 0.3. This guide bushing can quickly joined with the housing cover 3 and adjusted by means of the housing cover 3 on the radial flange 12, without necessitating any complicated assembly or adjustment of the guide bushing 7.

1. An electric power steering system, comprising a steering transmission housing and a housing cover which forms an axial closure of the steering transmission housing and which is penetrated by an axially displaceable component of the steering transmission wherein, in an axially outer region of the housing cover, a first guide bushing for the axially displaceable component is integrated in the housing cover, a second guide bushing is arranged at an axial distance from the first guide bushing, and the cross-sectional profile of the first and/or second guide bushing is formed in such a way that a linear contact of the axially displace able component is possible.

2. The electric power steering system according to claim 1, wherein the first guide bushing is cast with the housing cover as an insert in a casting mold for the housing cover.

3. The electric power steering system according to claim 1, wherein the second guide bushing, arranged at an axial distance from the first guide bushing is integrated in the housing cover and/or in the steering transmission housing.

4. The electric power steering system according to claim 1, wherein the first and/or second guide bushing is formed in one piece.

5. The electric power steering system according to claim 1, wherein the first guide bushing forms an axial stop for the axially displaceable component.

6. The electric power steering system according to claim 1, wherein the ratio of the guide diameter to the width of the first and/or second guide bushing is 0.3 to 3.5.

7. The electric power steering system according to claim 1, wherein the ratio of the wall thickness (W) to the outer diameter (D_{A}) of the first and/or second guide bushing is 0.01 to 0.3.

8. (canceled)

9. The electric power steering system according to claim 1, wherein the first and/or second guide bushing is mounted in a radially elastic manner.

10. The electric power steering system according claim 1, wherein the first and/or second guide bushing is disposed in the housing cover and/or in the steering transmission housing in a manner such that it can be positioned and fixed in the radial direction relative to the axially displaceable component.

11. The electric power steering system according to claim 10, wherein the first and/or second guide bushing is positioned by means of a device for fixing the radial position.

12. The electric power steering system according to claim 11, wherein the device for fixing the radial position comprises at least three adjusting screws which act in the radial direction on the first and/or second guide bushing.

13. The electric power steering system according to claim 12, wherein the device comprises one or more eccentrics.

14. The electric power steering system according to claim 1, wherein the first and/or second guide bushing is clamped by screws, or riveted, or caulked, or welded or adhesively bonded in the housing cover and/or in the steering transmission housing.

15. The electric power steering system according to claim 1, wherein means defining a cavity arranged radially around the first and/or second guide bushing between the first and/or second guide bushing and the housing cover and/or in the steering transmission housing, is filled with an elastically or non-elastically solidifying compound.

16. The electric power steering system according to claim 1, wherein the first and/or second guide bushing has guide surfaces for the axially displaceable component which prevent the axially displaceable component from rotating.

17. The electric power steering system according to claim 1, wherein in the circumferential direction of the outer surfaces thereof, the first and/or second guide bushing allows linear bearing of the axially displaceable component against the first and/or second guide bushing and/or linear bearing of the first and/or second guide bushing against the housing cover or steering transmission housing.

18. The electric power steering system according to claim 17, wherein the first and/or second guide bushing is formed in a rounded manner.

19. The electric power steering system according to claim 1, wherein the axially displaceable component is driven by an electric servomotor via a recirculating ball gear and a tip circle of the recirculating ball gear is shaped in such a way that the latter serves as a the radial bearing of the axially displaceable component.

20. The electric power steering system according to claim 1, wherein the first and/or second guide bushing is permanently lubricated and/or has lubricating grooves and/or lubricating pockets.

21. The electric power steering system according to claim 1, wherein the first and/or second guide bushing is formed from plastic, or from a composite material comprising metal and plastic, or from metal.

22. The electric power steering system according to claim 1, wherein one guide bushing is arranged at each axial end of the steering transmission housing.

23. The electric power steering system according to claim 1, wherein the electric power steering system is used in a power assisted steering system for a vehicle.
